(19) United States
(12) Patent Application Publication
(10) Pub. No.: US 2004/0251099 A1
(43) Pub. Date: Dec. 16, 2004

(54) Damper

(75) Inventors: Erwin Papp, Neumarkt (DE); Herbert Wolf, Altdorf (DE); Emil Frisch, Nurnberg (DE)

Correspondence Address: BROWDY AND NEIMARK, P.L.L.C., 624 NINTH STREET, NW, SUITE 300, WASHINGTON, DC, 20001-5303, US

(73) Assignee: SUSPA Holding GmbH, Altdorf (DE)

(21) Appl. No.: 10/841,491

(22) Filed: May 10, 2004

(30) Foreign Application Priority Data
Jun. 10, 2003 (DE) 103 26 482.5

(51) Int. Cl. F16F 9/34

(52) U.S. Cl. 188/322.15

(57) ABSTRACT

A damper comprises a piston rod which is disposed along a central longitudinal axis and extended out of an end of a casing through a guide and seal unit. A piston assembly on the end, inside the casing, of the piston rod divides the interior of the casing into two sectional casing chambers. A pressure-piston member and a traction-piston member of the piston assembly respectively comprise an flexibly deformable valve disk at a distance from their respective front walls. The piston assembly there-between comprises an annular piston which is movable relative to the piston rod along the axis between the valve disks in such a way that, by deformation conferred to the valve disk by the annular piston bearing against one of the valve disks, the valve disk rests on the associated piston member in such a way that a by-pass channel between the sectional casing chamber is at least narrowed. An additional valve assembly comprises a flexible valve body which bears by preload against a valve seat, and a through-channel which interconnects two sectional casing chambers that are sub-divided by the additional valve assembly and which is closed by the valve body in a blocked position of the valve assembly. A damper of this type may be used for example for damping the motion of turning down the seat of a vehicle.

### BACKGROUND OF THE INVENTION

1. Field of the Invention

The invention relates to a damper comprising a cylindrical casing with a central longitudinal axis; a piston rod, which is disposed along the central longitudinal axis and extended out of an end of the casing through a guide and seal unit; a piston assembly on the end, inside the casing, of the piston rod, which subdivides the interior of the casing into two sectional casing chambers that are at least partially filled with damping fluid, which comprises a pressure-piston member and a traction-piston member, which comprises a flexibly deformable pressure-valve disk at a distance from a front wall of the pressure-piston member and a flexibly deformable traction-valve disk at a distance from a front wall of the traction-piston member, which comprises an annular piston between the valve disks, the extension of which along the central longitudinal axis is less than the distance between the valve disks, which defines at least a bypass channel portion between the two valve disks, the bypass channel portion being part of a bypass channel which connects the two sectional casing chambers to each other, which is movable relative to the piston rod along the central longitudinal axis between the valve disks such that by deformation conferred to the valve disk by the annular piston bearing against one of the valve disks, the valve disk bears against the front wall of the piston member that is turned towards it so that the bypass channel is at least narrowed; an additional valve assembly, which is disposed in the casing along the central longitudinal axis at an axial distance from the piston assembly, which sub-divides the interior of the casing into two sectional casing chambers that are at least partially filled with damping fluid.

2. Background Art

A damper of the generic type is known from U.S. Ser. No. 09/412 356. By the aid of the piston assembly, blockage or an increased damping effect of the damper can be attained in the piston-rod push-in and push-out direction when a certain acceleration limit is exceeded in the piston-rod push-in or push-out direction. Upon acceleration below this limit i.e., upon rather restricted acceleration in the piston-rod push-in or push-out direction, this damper will keep its normal damping characteristic.

### SUMMARY OF THE INVENTION

In certain cases of application, there is a demand for a damper of the generic type which, starting from a certain acceleration limit that undershoots the damping characteristic mentioned above, will show a given normal damping characteristic, but which, when falling short of this acceleration limit, will block or damp more strongly as compared to the mentioned damping characteristic. It is an object of the invention to provide a damper of this type.

According to the invention, this object is attained in a damper wherein the additional valve assembly comprises a flexible valve body which bears by preload against a valve seat, a through-channel which connects the two sectional casing chambers to each other and which, in a blocked position of the valve assembly, is closed by the valve body.

The valve assembly according to the invention ensures that a connection of two sectional casing chambers is produced only after a certain preload has been overcome so that a given normal damping characteristic of the damper is obtained. Beyond the point of overcome of this preload i.e., above a first, lower acceleration limit, the damper has the normal damping characteristic. Below this first, lower acceleration limit and above the second, higher acceleration limit from which on the piston assembly reacts, the damper blocks or is strongly damped. Since the additional valve assembly can be embodied independently of the piston assembly, the two acceleration limits can be given independently of each other. A damper of this type can for instance be used for damping a motion of turning down the back of a vehicle seat. The damper according to the invention ensures that this turn-down motion is blocked or strongly damped upon normal running acceleration i.e., below the first acceleration limit, and moreover in the case of crash i.e., above the second acceleration limit; consequently, the back will not turn down or not turn down immediately. The blocking or strongly damping effect will be cancelled only in the range between the two acceleration limits, when the back is turned down manually, the damper then enabling the back to be turned down in a manner normally damped.

With at least one damping channel portion disposed in at least one of the piston members which cooperates with the associated valve disk such that, when the annular piston rests on this valve disk, the bypass channel remains open in the vicinity of the damping-channel portion of reduced cross section., this ensures flow to take place from one sectional casing chamber to the other even when the valve disk, which is allocated to the part of the piston that comprises the damping channel portion, is in a position for closing. In this case, the damper does not block, but is strongly damped as compared to the normal damping characteristic.

Damping channel portions in the form of a bypass groove on one of the front walls of a piston member and in the form of a recessed opening in one of the piston members, communicating with a recessed opening in the associated valve disk, can be produced at a low cost.

With the valve assembly embodied in such a way that, as from a first low acceleration limit, it will cancel the blocking position only in one direction of motion of the piston rod relative to the casing i.e, either in the push-in or push-out direction, a supplementary valve with a supplementary valve seat and a supplementary valve body ensures that damping fluid will flow back through the supplementary through-channel when the piston rod is moved in a direction opposite to the direction of motion that is blocked or strongly damped by the additional valve assembly.

A supplementary valve body can be embodied in a solid way when bearing by preload against the supplementary valve set, with the supplementary through-channel being such that it opens by overcoming the preload of the supplementary valve body when, in the blocked position of the valve assembly, the valve body is pressed against the valve seat by reason of the pressure difference between the sectional casing chambers. Moreover, the opening characteristic even of the supplementary valve can be influenced by the preload of the supplementary valve body bearing against the supplementary valve seat, so that backflow is possible only above a first low acceleration limit. The valve assembly then leads to blockage or strong damping in the piston-rod push-in as well as push-out direction below a first low acceleration limit. These first acceleration limits in both directions may be quite different.

A valve assembly, wherein a basic body of the additional valve assembly is fixed in relation to the casing, dividing the casing into a sectional energy-storing chamber and an additional sectional chamber, can replace a bottom valve, known per se, of a damper so that retrofitting of an available damper assembly is easily feasible.

A supplementary valve, wherein the basic body is an annular body; and wherein the supplementary valve body is a valve ring which, preloaded by a compressed spring, supports itself on the basic body by a valve rod which extends along the central longitudinal axis and through the basic body, is accompanied with comparatively restricted constructional requirements.

An annular channel between the valve rod and the basic body, the annular channel constituting a channel portion of the through-channel and simultaneously of the supplementary through-channel, is a clever way of connecting the functions of the through-channel on the one hand and the supplementary through-channel on the other.

A valve assembly can combine with the piston assembly to form a compact functional unit, when the additional valve assembly comprises another annular piston that is joined to the piston rod, with a sealing element being lodged by play in a sealing-element receptacle of the annular piston such that displacement of the sealing element along the central longitudinal axis opens the supplementary through-channel when, in the blocked position of the valve assembly, the valve body is pressed against the valve seat by reason of a pressure difference between the sectional casing chambers.

Details of the invention will become apparent from the ensuing description of exemplary embodiments, taken in conjunction with the drawing.

### BRIEF DESCRIPTION OF THE DRAWING

FIG. 1 is a longitudinal sectional view, repeatedly interrupted, of a damper;

FIG. 2 is an enlarged view of the piston assembly of the damper of FIG. 1 in a neutral position;

FIG. 3 is a view of the piston assembly of FIG. 2 in a position in which push-in acceleration above a second, higher acceleration limit acts on a piston rod of the damper;

FIG. 4 is a view of the piston assembly of FIG. 2 in a position in which push-out acceleration above a second, higher acceleration limit acts on the piston rod of the damper;

FIG. 5 is an enlarged view of a bottom-valve assembly of the damper of FIG. 1 in a neutral position;

FIG. 6 is a view of the bottom-valve assembly in a push-in position with the valve disk lifted off a circumferential step;

FIG. 7 is a view of the bottom-valve assembly in a push-out position with the closing body lifted off the basic body;

FIG. 8 is a longitudinal sectional view, repeatedly interrupted, of another embodiment of a damper;

FIG. 9 is a view, on an enlarged scale, of a piston assembly of the damper of FIG. 4;

FIG. 10 is a view of the piston assembly of FIG. 9 in a position in which push-in acceleration above a second, higher acceleration limit acts on a piston rod of the damper; and

FIG. 11 is a view of the piston assembly of FIG. 9 in a position in which push-out acceleration above a second, higher acceleration limit acts on a piston of the damper.

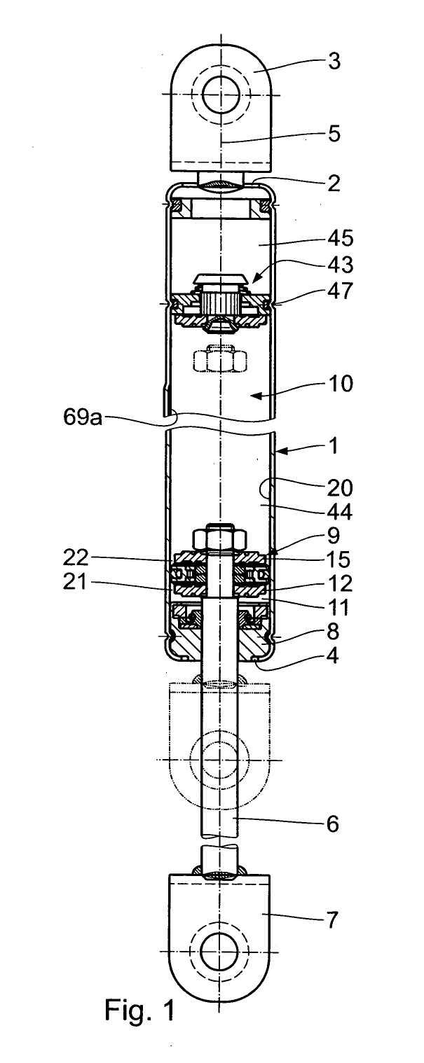

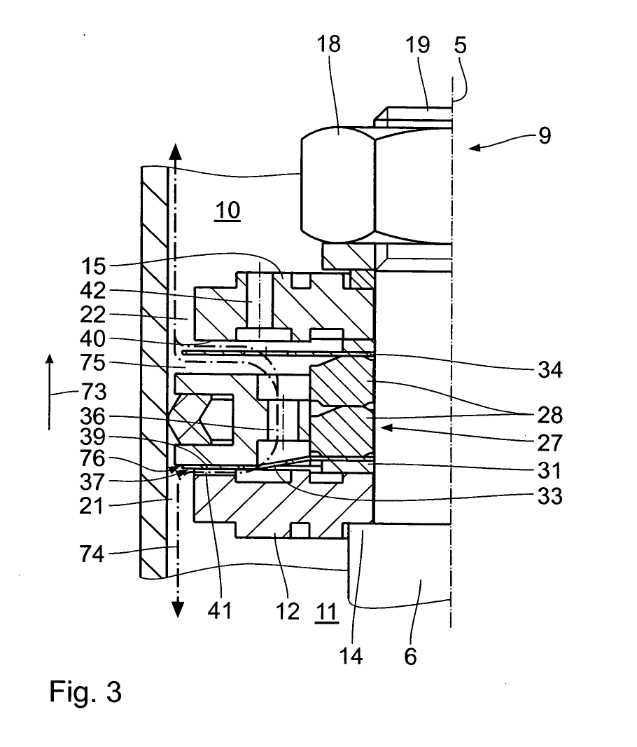

As seen in FIGS. 1 to 7, the damper, preloaded by compressed gas, comprises a substantially cylindrical casing 1 which is formed by a tube and, at one end, closed by a bottom 2. The damper is mounted upside down with the bottom 2 pointing upwards. A claw-type fastening element 3 is mounted on the bottom 2. A piston rod 6, which is coaxial of the central longitudinal axis 5 of the casing 1, is extended out of the end 4, opposite the bottom 2, of the damper. The outer free end of the piston rod 6 is provided with another fastening element 7 which, by design, corresponds to the fastening element 3 on the casing 1. At the end 4, the piston rod 6 is displaceably guided by a guide and seal unit 8 in the direction of the axis 5, however being gas and liquid tight. The casing 1 is largely filled with damping fluid as a damping medium.

The end of the piston rod 6 inside the casing 1 is provided with a piston assembly 9. It divides the interior of the casing 1 into two sectional casing chambers 10, 11, the sectional chamber 10 of which being formed between the piston assembly 9 and the bottom 2 and the sectional chamber 11 between the piston assembly 9 and the guide and seal unit 8.

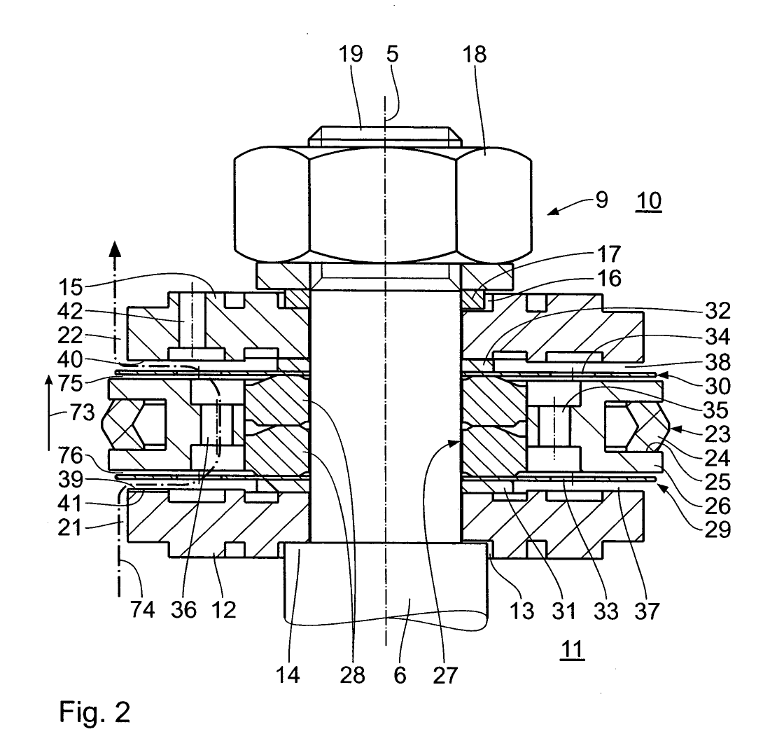

FIG. 2 shows the piston assembly 9 on an enlarged scale. It comprises a pressure-piston member 12, which is an annular disk comprising a circumferential groove 13 where a complementary shoulder 14 of the piston rod 6 is located so that the pressure-piston member 12 is secured against displacement relative to the piston rod 6 along the axis 5. The pressure-piston member 12 defines the piston assembly 9 towards the sectional chamber 11.

Towards the sectional chamber 10, the piston assembly 9 is defined by a traction-piston member 15, which is also an annular disk encircling the piston rod 6. On the side turned towards the sectional casing chamber 10, the traction-piston member 15 is provided with a circumferential groove 16 where a retaining ring 17 is located which is fixed on the piston rod 6, the traction-piston member 15 thus being safeguarded against any displacement relative to the piston rod 6 along the axis 5.

The pressure-piston member 12 and the traction-piston member 15 are disposed free from play on the piston rod 6 radially of the axis 15. In the direction of the axis 5 towards the sectional chamber 10, the traction-piston member 15 is retained by a nut 18 which is screwed on a corresponding thread 19 attached to the piston rod 6.

An annular gap 21 and 22 is respectively formed between the pressure-piston member 12 and the traction-piston member 15 on the one hand and an inside wall 20 of the casing 1 on the other. An annular piston 23, which is easily displaceable in the direction of the axis 5, is disposed between the piston members 12, 15. A sealing ring 24 of the annular piston 23 seals towards the inside wall 20 of the casing 1 so that the annular piston 23 overlaps the annular gaps 21, 22. The sealing ring 24 rests in a circumferential groove 25 of a support 26 of the annular piston 23. The annular support 26 is mounted for displacement relative to the piston rod 6 along the axis 5 by means of a piston bearing 27. The piston bearing 27 comprises two bearing sleeves 28 which are arranged axially side by side, encircling the piston rod 6. In addition to the bearing function, the piston bearing 27, which is level with the annular piston 23 and disposed centrally between the piston members 12 and 15, also has the job of a spacer. The extension of the piston bearing 27 in the direction of the axis 5 exceeds the corresponding extension of the annular piston 23. A pressure-valve disk 29, turned towards the pressure-piston member 12, and a traction-valve disk 30, turned towards the traction-piston member 15, bear against the piston bearing 27 on both sides thereof, a respective annular spacer plate 31 and 32 being disposed between the disks 29 and 30 and the neighboring piston member 12 and 15. The package including the traction-piston member 15, spacer plate 32, traction-valve disk 30, piston bearing 27, pressure-valve disk 29, and pressure-piston member 12 is clamped together in the direction of the axis 5 by the aid of the nut 18.

The annular valve disks 29 and 30 have damping passages 33 and 34. These passages 33 and 34 are substantially in alignment with bypass-channel portions 35, 36 which are embodied as through-holes that are parallel to the axis 5, facing each other in relation to the axis 5.

The valve disks 29, 30 are made of spring steel, having a thickness of for example 0.1 mm. The outside diameter of the valve disks 29, 30 is less than the inside diameter of the casing 1.

In the condition of rest, seen in FIG. 2, of the piston assembly 9, a radial channel 37 is formed between the pressure-valve disk 29 and the pressure-piston member 12, connecting the bypass-channel portions 35, 36 to the annular gap 21. A radial channel 38 is formed between the traction-valve disk 30 and the traction-piston member 15 in the condition of rest, connecting the bypass-channel portions 35, 36 to the annular gap 22. Bypass grooves 41 may be provided on front walls 39, 40 of the piston members 12 and 15; they run radially of the axis 5 and are allocated to the respective damping passage 33, 34, lapping therewith radially of the axis 5 and mouthing into the respective annular gap 21, 22.

By alternative of, or in addition to, such a bypass groove 41, a recessed opening 42 may be provided in the pressure-piston member 12 or traction-piston member 15, running parallel to the axis 5 and connecting the radial channel 37 and 38 to the sectional chamber 10 and 11. The bypass groove 41 and the recessed opening 42 are variants of a damping-channel section of the piston assembly 9.

In addition to the piston assembly 9, the damper according to FIGS. 1 to 7 still comprises a valve assembly 43 in proximity to the bottom 2, dividing the sectional chamber 10 into a first sub-sectional chamber 44 between the piston assembly 9 and the valve assembly 43, and a second sub-sectional chamber 45 between the valve assembly 43 and the bottom 2. The sub-sectional chamber 45 is a compressed-gas chamber containing compressed gas as a damping medium and working as an energy storing device. The sub-sectional chamber 11 and the sub-sectional chamber 44 are filled with hydraulic oil as damping fluid.

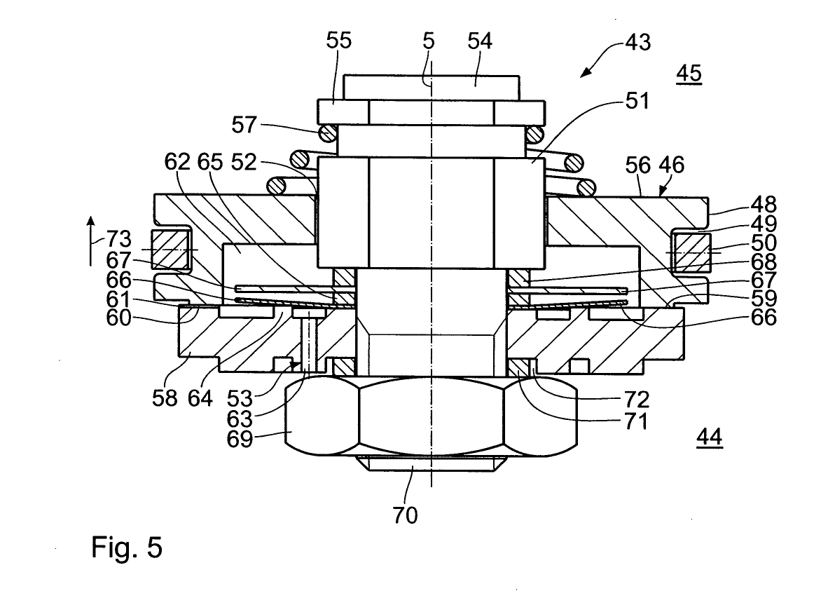

FIG. 5 illustrates the valve assembly 43 on an enlarged scale. An annular basic body 46 is fixed in place on an elevation 47 that encircles on the inside wall 20 of the casing 1 in an axial position near the bottom 2. To this end, the basic body 46 possesses a circumferential groove 49 in the vicinity of the elevation 47, the groove 49 being provided on a jacket wall 48 that neighbors the inside wall 20. The outside diameter of the jacket wall 48 exceeds the inside diameter of the elevation 47 so that the inside wall 20 partially projects into the circumferential groove 49 in the vicinity thereof. The basic body 46 is thus safeguarded against axial displacement along the axis 5 in relation to the casing 1. A sealing ring 50 is placed into the circumferential groove 49, sealing the basic body 46 towards the inside wall 20. The basic body 46 encloses a guide sleeve 51 with play so that a through-channel portion 52 of a through-channel 53 forms between the outside wall of the guide sleeve 51 and the opposite inner jacket wall of the basic body 46, interconnecting the sub-sectional chambers 44, 45 when the valve assembly 43 is open.

The guide sleeve 51 fits tightly on a valve rod 54 of the valve assembly 43. An end portion of the valve rod 54 that projects into the sub-sectional chamber 45 is provided with a retaining ring 55. A helical spring 57 supports itself between the retaining ring 55 and a front wall 56 that faces the sub-sectional chamber 45, its inside diameter corresponding to the outside diameter of the valve rod 54 where it rests on the retaining ring 55. The inside diameter of the helical spring 57 grows towards the basic body 46 so that the spring 57 encloses the guide sleeve 51 with play.

A closing body 58 is fixed in place on the valve rod 54 on the side of the basic body 46 that faces the sub-sectional chamber 44. In the closing position of the valve assembly 43 seen in FIG. 5, front walls 59, 60, facing each other, of the closing body 58 and of the basic body 46, rest on one another. A radial bypass groove 61 is formed on the front wall 59 of the closing body 58. It connects the sub-sectional chamber 44 to an annular channel 62 of the valve assembly 43 which is defined by the basic body 46 that encloses the annular channel 62 in the way of a cup on the one hand, and by the closing body 58 that closes the annular channel 62 in the way of a cover on the other hand. The annular channel 62 encircles the valve rod 54.

Another through-channel portion 63, which is part of the through-channel 53, is embodied as a through-hole running parallel to the axis 5. The through-channel portion 63 connects the sub-sectional chamber 44 to the annular channel 62. On its outward side radially of the axis 5, the end portion, mouthing into the annular channel 62, of the through-channel portion 63 is defined by a circumferential step 64 of the closing body 58, the step 64 encircling the valve rod 54 coaxially. The circumferential step 64 stands out from the front wall 59, projecting farther into the annular channel 62 than the area of the front wall 59 that defines this end portion of the through-channel portion 63 radially inwards. In this area, a valve disk 66, which encircles the valve rod 54 annularly, is disposed between the closing body 58 and a spacer ring 65 which equally encircles the valve rod 54. In the closing position seen in FIG. 5, in which it closes the through-channel portion 63, this valve disk 66 bears against the circumferential step 64, which takes the function of a valve seat. Owing to the above-mentioned projecting length of the circumferential step 64 into the annular channel 62, the valve disk 66, equally consisting of spring steel, is bent slightly in the direction towards the annular channel 62, thus resting by pre-load on the circumferential step 64.

A back-up ring 67 is disposed opposite the front wall 59 in relation to the valve disk 66, encircling the valve rod 54. The back-up ring 67 is disposed between the spacer ring 65 and another spacer ring 68 which encircles the valve rod 54. The ring 68 is located between the back-up ring 67 and the guide sleeve 51. The back-up ring 67 defines the path of displacement of the valve disk 66.

In the direction of the axis 5 towards the sub-sectional chamber 44, the closing body 58 is retained by a nut 69 which is screwed on a corresponding thread 70 attached to the valve rod 54. A retaining ring 71 is disposed between the nut 69 and the closing body 58, resting in a circumferential groove 72 of the closing body 58. By the aid of the nut 69, the package including the retaining ring 71, closing body 58, valve disk 66, spacer ring 65, back-up ring 67 and spacer ring 68 is clamped together in the direction of the axis 5 on the valve rod 54.

A longitudinal groove 69a is executed on the inside wall 20 of the casing 1 along the central longitudinal axis 5, the inner cross-section of the casing 1 expanding along the groove 69a. The longitudinal groove 69a has an axial extension that is less than the length of displacement of the piston assembly 9 inside the casing 1. This axial extension as well as the axial position of the longitudinal groove 69a depend on the respective field of application of the damper.

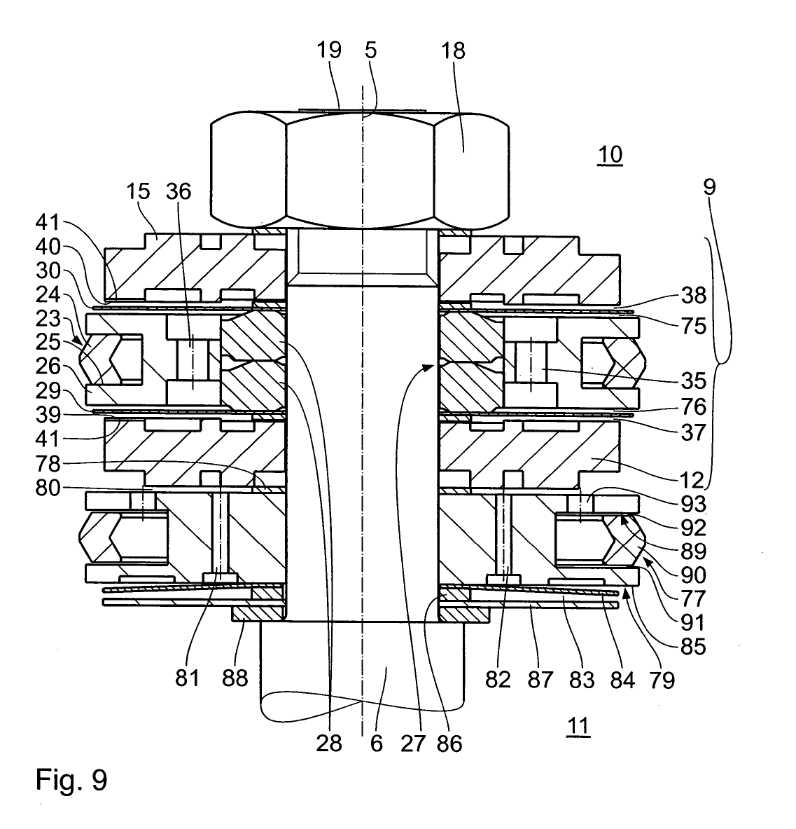

The mode of operation of the damper is as follows: Upon push-in acceleration of the piston rod 6 in the push-in direction 73 ranging between a first lower acceleration limit and a second higher acceleration limit, the annular piston 23 bears against the pressure-valve disk 29 without substantially bending it in the direction of the axis 5. Since the annular piston 23 has an axial extension that is inferior to the piston bearing 27 that also works as a spacer, damping fluid flows in accordance with a dashed flow line 74 (roughly outlining a bypass channel) from the sectional casing chamber 10 through the annular gap 22, the radial channel 38, the damping passages 34 in the draw-valve disk 30, the bypass-channel sections 35, 36, the damping passages 33 in the pressure-valve disk 29, the radial channel 37 as well as the annular gap 21, and into the sectional casing chamber 11. Additionally, damping fluid flows from the annular gap 22 externally around the traction-valve disk 30 and another radial channel 75 between the draw-valve disk 30 and the annular piston 23, towards the bypass-channel portions 35, 36. In this case, the annular piston 23 rests closely on the area of the pressure-valve disk 29 that is located outside the damping passages 33. When the push-in acceleration of the piston rod 6 in the push-in direction 73 increases beyond the second, higher acceleration limit, then the pressure of the damping fluid on the annular piston 23 on the one hand and on the pressure-valve disk 29 on the other rises to such an extent that the pressure-valve disk 29 is deflected as far as to the pressure-piston member 12, bearing sealingly against the front wall 39 thereof. This position of the piston assembly 9 is seen in FIG. 9. Thus the radial channel 37 is closed except for the bypass groove 41. Therefore, the damping force rises suddenly, possibly reaching a range where the damper is blocked if for example no bypass channels 41 are provided and if only minor leakages exist in the overall piston assembly 9.

When the piston rod 6 is pulled or pushed out of the casing 1 counter to the push-in direction 73 by push-out acceleration in the range between a first lower acceleration limit and a second higher acceleration limit, the annular piston 23 will bear against the traction-valve disk 30 without however deforming it in the direction of the axis 5. Then the damping fluid flows in accordance with a flow line 74 (roughly outlining a bypass channel) from the sectional casing chamber 11 through the annular gap 21, the radial channel 37, the damping passages 33, the bypass-channel portions 35, 36, the damping passages 34, the radial channel 38 as well as the annular gap 22 and into the sectional casing chamber 10. Moreover, damping fluid flows from the annular gap 21 externally around the pressure-valve disk 29 and another radial channel 76 formed between the disk 29 and the annular piston 23, and towards the bypass-channel sections 35, 36.

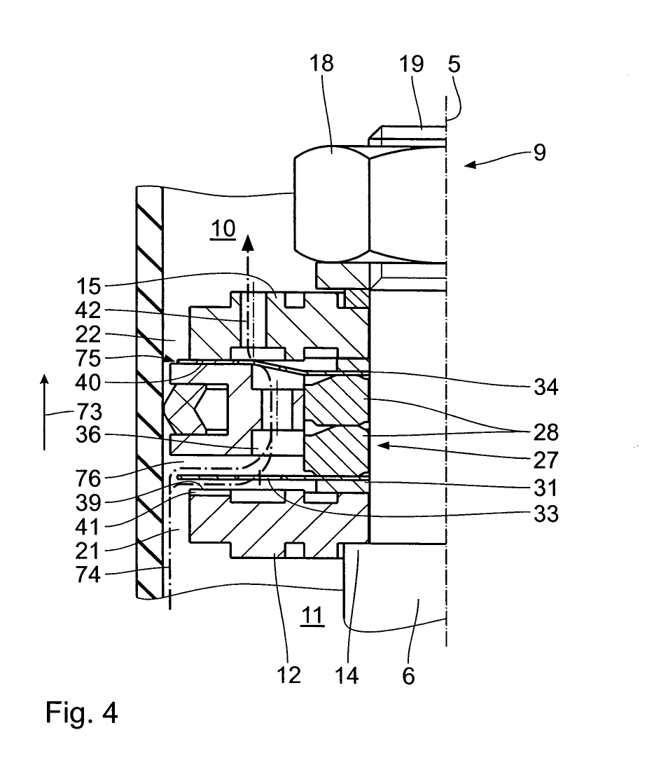

When the push-out acceleration exceeds the second higher acceleration limit, then the banking-up pressure that acts on the annular piston 23 and the traction-valve disk 30 rises to such an extent that the traction-valve disk 30 deforms flexibly, bearing against the front wall 40 of the traction-piston member 15, so that the damping fluid can flow via bypass grooves (not shown in FIGS. 1 to 7) of the front wall 40 of the traction-piston member 15 or, respectively, via the recessed opening 42 in a direction towards the sectional casing chamber 10. This position of the piston assembly 9 is seen in FIG. 4. The damping effect rises suddenly. As regards any overstepping of the second higher acceleration limit, the damping and blocking conditions are fundamentally the same when the piston rod 6 is pushed into or out of the casing 1, it being possible that the respective second and higher acceleration limit differs.

The terms “pressure-piston member 12” and “pressure-valve disk 29” have been chosen because they enter into function when pressure acts on the damper i.e., upon insertion of the piston rod 6 into the casing 1, whereas the “traction-piston member 15” and the “traction-valve disk 30” enter into function when traction acts on the damper i.e., upon extension of the piston rod 6 out of the casing 1.

The second higher acceleration limit of piston-rod-6 insertion and extension, which occasions simple damping to jump to approximate blockage, can be modified by modification of the thickness or material of the valve disks 29, 30. The thicker the valve disks 29, 30, the more rigid they are, i.e. there is an increase in the acceleration limit which occasions simple damping to pass to quasi blockage. The thinner the valve disk 29 and 30, the lower is the second higher acceleration limit.

In like manner, modification of the axial extension of the piston bearing 27 in the direction of the axis 5 may serve to modify the length in the direction of the axis 5 that the respective valve disk 29, 30, starting from its position of rest, must cover until the respective radial channel 37, 38 is being closed. Since the force, which is provided by the banking-up pressure and which is necessary for deformation of the valve disk 39, 30 in the direction of the axis 5, augments along with the length needed for deformation, the corresponding acceleration limit decreases upon reduced axial extension of the piston bearing 27 and vice versa.

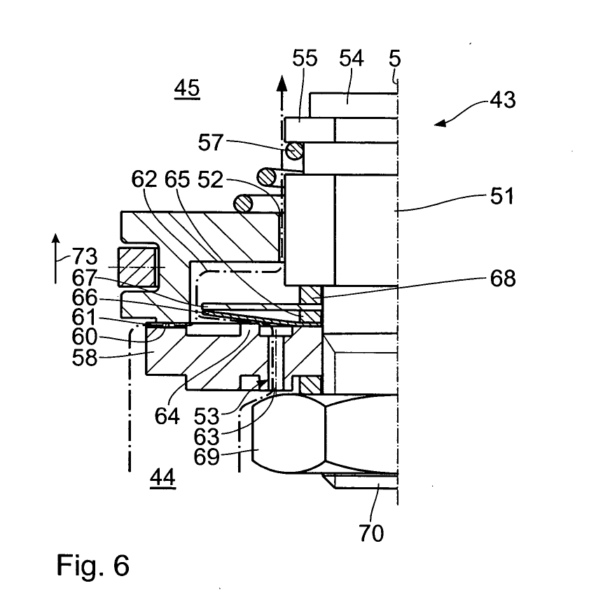

Insertion of the piston rod 6 into the casing 1 requires the additional piston-rod volume that is pushed into the casing 1 to be able to flow in the form of a corresponding volume of damping fluid, from the entirety of the sub-sectional chamber 44 on the one hand and the sectional chamber 11 on the other into the sub-sectional chamber 45. As long as there is no possibility of this kind of overflow, i.e. as long as the valve assembly 43 is closed, the damper is blocked even when the piston assembly 9 is open, enabling damping fluid to flow along the flow line 74. This is the case in a range below the first lower acceleration limit, as will be explained in the following, based on a functional description of the valve assembly 43: only when the banking-up pressure in the sub-sectional chamber 44 exceeds a certain pressure because the first lower acceleration limit is overstepped, this banking-up pressure, which also exists in the through-channel portion 63, will lift the valve disk 66 off the circumferential step 64. This situation is illustrated in FIG. 6. Damping fluid can flow through the through-channel portion 63, the annular channel 62, and the through-channel portion 52 into the sub-sectional chamber 45, insertion of the piston rod 6 by the valve assembly 43 not being prevented.

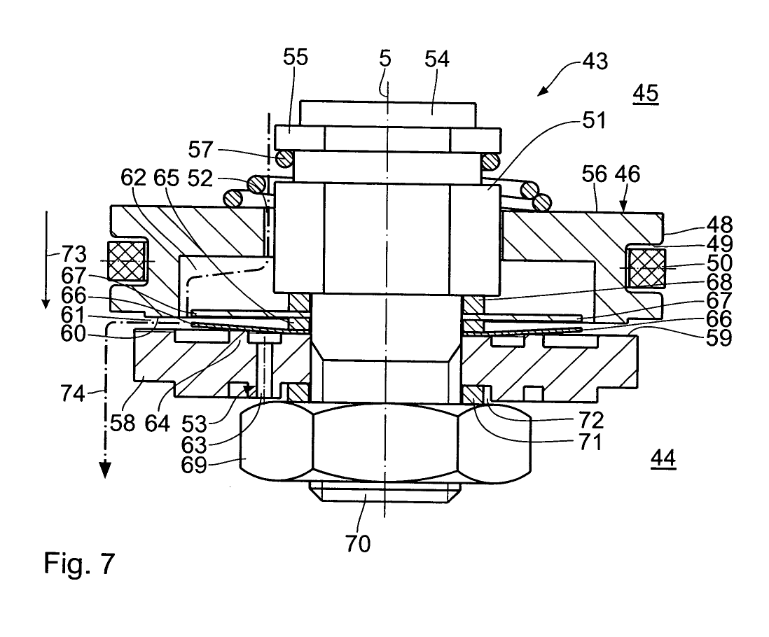

Extension of the piston rod 6 produces partial vacuum in the sub-sectional chamber 44 as compared to the sub-sectional chamber 45, causing the valve rod 54 to be displaced in the push-out direction in relation to the basic body 46 and against the force of the helical spring 57 along the axis 5. In doing so, the closing body 58, which is tightly united with the valve rod 54, lifts off the basic body 46 so that a supplementary through-channel portion is produced in the form of a radial channel between the front wall 59 of the closing body 58 and the front wall 60 of the basic body 46. This situation is illustrated in FIG. 7. Owing to the upside down arrangement, damping fluid may then flow under the action of gravity from the sub-sectional chamber 45 via the through-channel portion 52, the annular channel 62 and the radial channel that has originated into the sub-sectional chamber 44 so that extension of the piston rod 6 is the case even if the valve disk 66 closes the through-channel portion 63 by bearing sealingly against the circumferential step 64. Even when, by reason of the preload of the helical spring 57, the closing body 58 rests again closely on the basic body 46, there will be strongly damped back-flow of damping fluid from the sub-sectional chamber 45 into the sub-sectional chamber 44 or vice versa if necessary.

As long as push-in acceleration is below the first lower acceleration limit, the through-channel portion 63 remains closed by the valve disk 66 that rests sealingly on the circumferential step 64. Insertion of the piston rod 6 into the casing 1 is not possible, or hardly possible if for instance bypass grooves are available, below the first lower acceleration limit by reason of the valve assembly 43 on the one hand, and above the second higher acceleration limit by reason of the piston assembly 9 on the other hand.

As long as the annular piston 23, when on a level with the longitudinal groove 69a, slides on the inside wall 20 of the casing 1, strongly damped flow between the sectional casing chambers 10, 11 is possible via the longitudinal groove 69a. In the axial range of the longitudinal groove 69a, complete blockage of the damper is cancelled because of the possibility of flow through the longitudinal groove 69a. The longitudinal groove 69a serves as a bypass. The number of longitudinal grooves 69a as well as the enlarged inner cross-section of the casing 1 produced by a longitudinal groove 69a and the axial extension and position of the longitudinal grooves 69a in relation to the casing 1 can be adapted for control of the operating forces and operating rates.

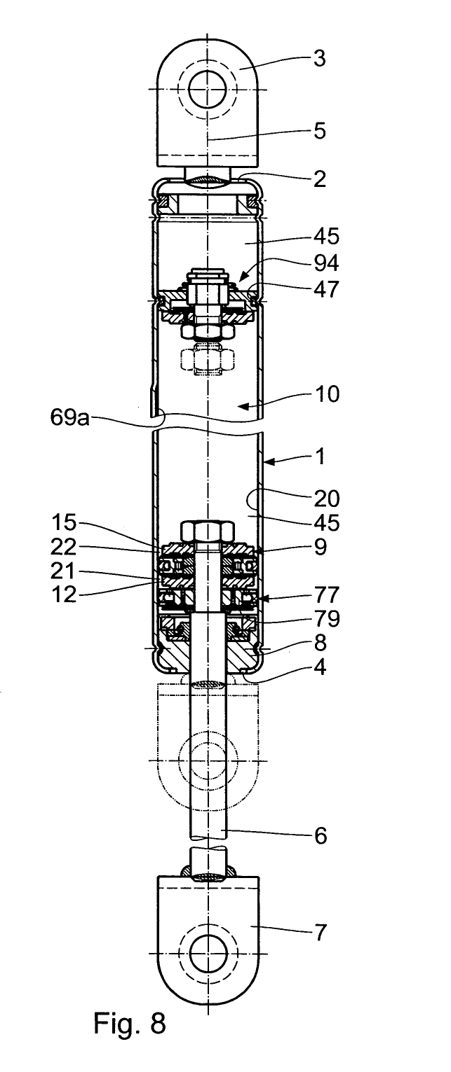

Another embodiment of a damper is illustrated in FIGS. 8 to 11. Components that correspond to those described with reference to FIGS. 1 to 7 have the same reference numerals and will not be described in detail again.

A valve assembly 77 is mounted between the piston assembly 9 and the guide and seal unit 8. Between the valve assembly 77 and the piston assembly 9, provision is made for a spacer ring 78 which produces a distance between the pressure-piston member 12 and a basic body 79 of the valve assembly 77. In this way, a radial channel 80 is produced between the pressure-piston member 12 and the basic body 79. Bypass channel portions 81, 82 are provided in the basic body 79 in the form of opposed through-holes that are parallel to the axis 5. They connect the radial channel 80 to another radial channel 83 on the opposite front side of the basic body 79. Where the bypass channel portions 81, 82 open into the radial channel 83, they may be closed by a valve disk 84 which, in a closing position (not shown), rests planely on a front wall 85, facing the radial channel 83, of the basic body 79. The valve disk 84 is embodied as a ring encircling the piston rod 6, as are the valve disks 29, 30, 66. In the section adjoining the piston rod 6, the valve disk 84 is disposed between the basic body 79 and a spacer ring 86. The spacer ring 86 creates a distance between the valve disk 84 and a back-up ring 87 along the axis 5. An inner section of the back-up ring 87 in vicinity to the piston rod 6 is disposed between the spacer ring 86 and another spacer ring 88. The back-up ring 87 has the same task as the back-up ring 67 of the embodiment according to FIGS. 1 to 3: it defines the displacement of the valve disk 84. The outside diameter of the basic body 79, the valve disk 84 and the back-up ring 87 is less than the inside diameter of the casing 1.

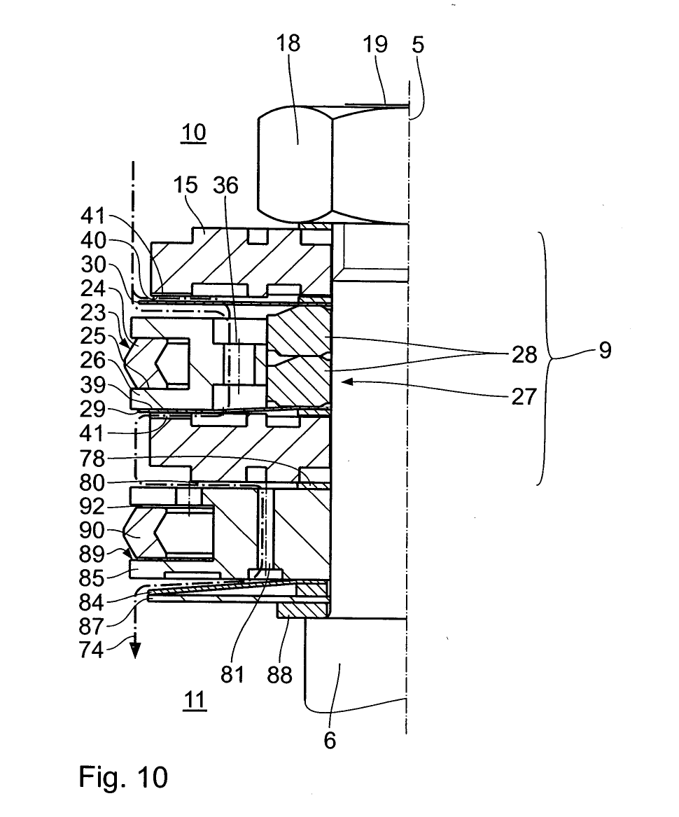

In the embodiment according to FIGS. 9 and 10, the package including the components of the piston assembly 9, the spacer ring 78, the basic body 79, the valve disk 84, the spacer ring 86, the back-up ring 87 and the spacer ring 88 is clamped together in the direction of the axis 5 by the aid of the nut 18.

A sealing ring 90 is lodged in an outer circumferential groove 89 of the basic body 79, sealingly separating the sectional chamber 11 between the valve assembly 77 and the guide and seal unit 8 from the radial channel 80; it seals towards the inside wall 20 of the casing 1. The extension of the sealing ring 90 along the axis 5 is inferior to the width of the circumferential groove 89 along the axis 5. The sealing ring 90, by reason of the play along the axis 5 that results therefrom, can move freely in relation to the basic body 79 along the axis 5 within the limits of this play. In the central position of the sealing ring 90 relative to the basic body 79 seen in FIG. 9, two radial channels 91, 92 remain between the sealing ring 90 and the front walls, facing it, of the circumferential grooves 89. The radial channel 92, which adjoins the radial channel 80 between the basic body 79 and the pressure-piston member 12, is connected to the radial channel 80 via a supplementary through-channel 93.

As for its function, the valve assembly 77 corresponds to the valve assembly 43: it blocks the damper of FIGS. 8 and 9 as far as to a first low acceleration limit with regard to the force of insertion of the piston rod 6 into the casing 1. Below the first low acceleration limit, the banking-up pressure exercised by way of the bypass channel portions 81, 82 on the valve disk 84 is not sufficient for lifting the valve disk 84 off the front wall 85 of the basic body 79. The damper blocks. Owing to the push-in force when the piston rod 6 is tried to be inserted into the casing 1, the sealing ring 90 simultaneously rests on the front wall, adjoining the valve disk 84, of the circumferential groove 89 so that the radial channel 91 is closed. Damping fluid cannot flow from the radial channel 83 to the radial channel 80.

When the first lower acceleration limit is exceeded upon insertion, the valve disk 84 is lifted off the front wall 85 by reason of the banking-up pressure in the bypass channel portions 81, 82 so that the damping fluid may flow from the radial channel 80 via the bypass channel portions 81, 82 and the radial channel 83 externally past the back-up ring 87 and into the sectional chamber 11. If the second higher acceleration limit—which provides for blockage of the piston assembly 9 according to what has been said above in connection with FIGS. 1 to 7—has not yet been reached, flow of damping fluid between the sectional casing chambers 10 and 11 is possible. Consequently, damped insertion of the piston rod 6 into the casing 1 is possible.

FIG. 10 illustrates the situation that results when the second higher acceleration limit is reached or exceeded. The ring piston 23 has deflected the pressure-valve disk 29 as far as to the pressure-piston member 12 so that strongly damped flow is possible between the sectional casing chambers 10 and 11 regardless of the position of the valve disk 84.

Upon extension of the piston rod 6 out of the casing 1, the valve disk 84 rests on the front wall 85, owing to the banking-up conditions prevailing, so that the bypass channel portions 81, 82 are closed. Simultaneously, the sealing ring 90 moves along the axis 5 in the circumferential groove 89 in such a way that the radial channel 92 is closed and the radial channel 91 opens further.

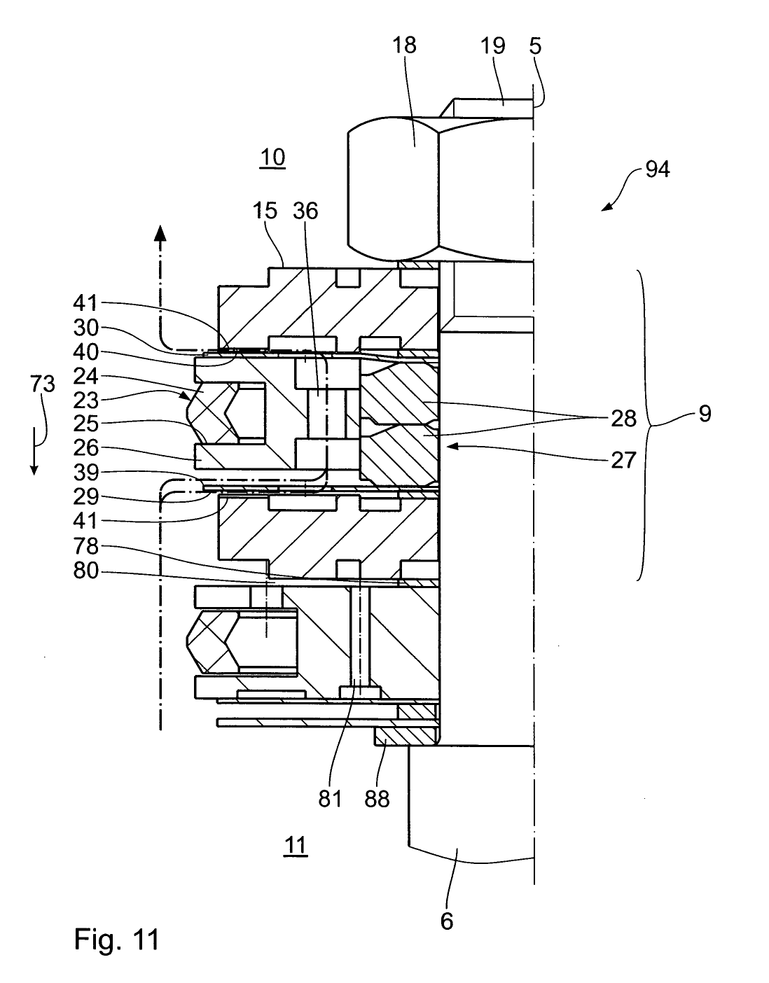

Damping fluid may therefore flow from the radial channel 83 externally past the circumferential wall, adjoining the valve disk 84, of the basic body 79, through the radial channel 91, right through the sealing ring 90, through the supplementary through-channel 93 and the radial channel 80, towards the piston assembly 9. Provided the second higher acceleration limit for extension of the piston rod 6 out of the casing 1 has not yet been reached, flow of damping fluid is possible from the sectional casing chamber 11 into the sectional casing chamber 10. Damped extension of the piston rod 6 out of the casing 1 can take place. FIG. 11 illustrates the situation when the second higher acceleration limit for extension of the piston rod 6 out of the casing 1 has been reached or exceeded. In this case, the traction-valve disk 30 is deflected by the annular piston 23 in a direction towards the traction-piston member 15 so that strongly damped flow of damping fluid is possible between the sectional casing chambers 11 and 10.

Instead of the valve assembly 43, the damper of the embodiment according to FIGS. 8 to 11 comprises a conventional bottom valve 94 without a valve disk 66 and back-up ring 67, this valve 94 enabling damped flow of the damping fluid from the sub-sectional chamber 44 into the sub-sectional chamber 45. Bottom valves 94 of this type are known to those experienced in the art.

What is claimed is:

1. A damper, comprising
a cylindrical casing (1) with a central longitudinal axis (5);
a piston rod (6), which is disposed along the central longitudinal axis (5) and extended out of an end (4) of the casing (1) through a guide and seal unit (8);
a piston assembly (9) on the end, inside the casing (1), of the piston rod (6),
which subdivides the interior of the casing (1) into two sectional casing chambers (10, 11) that are at least partially filled with damping fluid,
which comprises a pressure-piston member (12) and a traction-piston member (15),
which comprises a flexibly deformable pressure-valve disk (29) at a distance from a front wall (39) of the pressure-piston member (12) and a flexibly deformable traction-valve disk (30) at a distance from a front wall (40) of the traction-piston member (15),
which comprises an annular piston (23) between the valve disks (29, 30),
the extension of which along the central longitudinal axis (5) is less than the distance between the valve disks (29, 30),
which defines at least a bypass channel portion (35, 36) between the two valve disks (29, 30), the bypass channel portion (35, 36) being part of a bypass channel (74) which connects the two sectional casing chambers (10, 11) to each other,
which is movable relative to the piston rod (6) along the central longitudinal axis (5) between the valve disks (29, 30) such that by deformation conferred to the valve disk (29, 30) by the annular piston (23) bearing against one of the valve disks (29, 30), the valve disk (29, 30) bears against the front wall (39, 40) of the piston member (12, 15) that is turned towards it so that the bypass channel (74) is at least narrowed;
an additional valve assembly (43; 77),
which is disposed in the casing (1) along the central longitudinal axis (5) at an axial distance from the piston assembly (9),
which subdivides the interior of the casing (1) into two sectional casing chambers (44, 45; 10, 11) that are at least partially filled with damping fluid;
wherein the additional valve assembly (43; 77) comprises
a flexible valve body (66; 84) which bears by preload against a valve seat (64; 85),
a through-channel (53; 81, 82) which connects the two sectional casing chambers (44, 45; 10, 11) to each other and which, in a blocked position of the valve assembly (43; 77), is closed by the valve body (66; 84).

2. A damper according to claim 1, comprising at least one damping channel portion (41, 42) in at least one of the piston members (12, 15), which cooperates with the associated valve disk (29, 30) such that, when the annular piston (23) rests on this valve disk (29, 30), the bypass channel (74) remains open in the vicinity of the damping-channel portion (41, 42) of reduced cross section.

3. A damper according to claim 2, wherein the damping channel portion (41) is a bypass groove on one of the front walls (39) of a piston member (12).

4. A damper according to claim 2, wherein the damping channel portion (42) is a recessed opening in one of the piston members (15), communicating with a recessed opening (34) in the associated valve disk (30).

5. A damper according to claim 1, wherein the additional valve assembly (43; 77) comprises
a supplementary valve with a supplementary valve seat (60; 89) and a supplementary valve body (58; 90);
a supplementary through-channel (52, 62; 91, 93) which connects the two sectional casing chamber (44, 45; 10, 11) to each other, with the supplementary valve opening the supplementary through-channel (52, 62; 91, 93) when, in a blocked position of the valve assembly (43; 77), the valve body (66; 84) is pressed against the valve seat (64; 85) by reason of pressure difference between the sectional casing chambers (44,45; 10, 11).

6. A damper according to claim 5, wherein the supplementary valve body (58) bears by preload against the supplementary valve seat (60), with the supplementary through-channel (52, 62) being such that it opens by over-coming the preload of the supplementary valve body (58) when, in the blocked position of the valve assembly (43), the valve body (66) is pressed against the valve seat (60) by reason of the pressure difference between the sectional casing chambers (44, 45).

7. A damper according to claim 1, wherein a basic body (46) of the additional valve assembly (43) is fixed in relation to the casing (1), dividing the casing (1) into a sectional energy-storing chamber (45) and an additional sectional chamber (44).

8. A damper according to claim 6, wherein the basic body (46) is an annular body; and wherein the supplementary valve body (58) is a valve ring which, preloaded by a compressed spring (55), supports itself on the basic body (46) by a valve rod (54) which extends along the central longitudinal axis (5) and through the basic body (46).

9. A damper according to claim 8, comprising an annular channel (52) between the valve rod (54) and the basic body (46), the annular channel (52) constituting a channel portion of the through-channel (53) and simultaneously of the supplementary through-channel (52, 62).

10. A damper according to claim 1, wherein the additional valve assembly (77) comprises another annular piston (79, 90) that is joined to the piston rod (6), with a sealing element (90) being lodged by play in a sealing-element receptacle (89) of the annular piston (79, 90) such that displacement of the sealing element (90) along the central longitudinal axis (5) opens the supplementary through-channel (91, 93) when, in the blocked position of the valve assembly (71), the valve body (84) is pressed against the valve seat (85) by reason of a pressure difference between the sectional casing chambers (10, 11).
